(19) United States
(12) Patent Application Publication
(10) Pub. No.: US 2006/0181974 A1
(43) Pub. Date: Aug. 17, 2006

(54) Track jump apparatus and method which perform track jumping considering position of pickup

(76) Inventor: Moon-Soo Han, Suwon-si (KR)

Correspondence Address: STEIN, MCEWEN & BUI, LLP, 1400 EYE STREET, NW, SUITE 300, WASHINGTON, DC, 20005, US

(21) Appl. No.: 10/564,892

(22) PCT Filed: Jul. 9, 2004
(86) PCT No.: PCT/KR04/01696

§ 371 Date: Jan. 17, 2006

(30) Foreign Application Priority Data
Jul. 15, 2003 (KR) 10-2003-00048307

(51) Int. Cl. G11B 7/00

(52) U.S. Cl. 369/44.28

(57) ABSTRACT

An apparatus for and a method of performing track jumping of an optical pickup in an optical disc recording/reproducing apparatus. A controller monitors a control signal indicating a position of the optical pickup relative to a center of a track and controls the track jump so that the track jump is delayed if the optical pickup is not within a predetermined range of the center of the track.

### TECHNICAL FIELD

The present invention relates to an optical disc record/playback apparatus and method, and more particularly, to a track jump apparatus and method which perform track jumping in consideration of the position of a pickup and the position of a lens of the pickup in an optical recording medium and system with eccentricity.

### BACKGROUND ART

A track is a field in an optical disc in which data is written, and rotation eccentricity of a disc occurs due to eccentricity of a disc and eccentric chucking of the disc. Rotation eccentricity is a phenomenon generated due to discord between the spindle rotation axis of an optical disc and the track center of the optical disc.

Since the rotation eccentricity causes unstableness in a servo system when movement between tracks (hereinafter, track jump) is performed, besides the distance that must be moved when the track jump is performed, offset deviation and movement deviation due to the rotation eccentricity occur. Offset deviation and movement deviation cause track sliding and a focus drop.

FIG. 1 is a block diagram of a conventional servo system for a track jump.

With reference to FIG. 1, the servo system includes an optical disc 100, a pickup 101 including a cover 101-1, a lens 101-2, and a coil 101-3, a radio frequency (RF) processing unit 102, which generates several error signals controlling the pickup 101 by shaping and amplifying a signal detected from the pickup 101, a servo 103, which controls the error signals output from the RF processing unit 102, and a driver 104, which drives the pickup 101 by amplifying the control signal output from the servo 103.

When the servo system of FIG. 1 is tracking the optical disc 100, the RF processing unit 102 outputs an error signal by shaping and amplifying an output signal of the pickup 101. The servo 103 outputs an error compensation signal, which is a control signal, by converting the error signal output from the RF processing unit 102 into a digital signal and filtering the digital signal. The driver 104 amplifies the error compensation signal output from the servo 103 and outputs the amplified error compensation signal to the pickup 101. With the above processes, the servo system maintains tracking.

If a track jump is performed while tracking the optical disc 100, the servo 103 cuts off the error compensation signal output to the driver 104 and outputs a kick voltage to the driver 104. Then, the servo 103 calculates a track to be jumped and sets an output time of a break voltage. When the pickup 101 arrives at the target track, the servo 103 outputs the break voltage to the driver 104.

The description of a track jump in a servo system is disclosed in U.S. Pat. No. 6,226,246.

For tracking in the conventional servo system, the servo 103 outputs the error compensation signal, which is the control signal, obtained from the RF processing unit 102. However, if the rotation eccentricity is generated in the optical disc 100 and a system driving the optical disc 100, the range of variation of the error signal output from the RF processing unit 102 is large and unstable due to the same cycle component as a cycle of a rotation eccentricity frequency. That is, the lens 101-2 in the pickup 101 sways to the track direction for tracking.

If the track jump is performed while the lens is swaying due to the rotation eccentricity, the lens 101-2 is bumped into the cover 101-1 protecting the pickup 101 due to the kick voltage for performing the track jump. Also, if the lens 101-2 moves on outward an operation range where the lens 101-2 can move to the track direction, the lens 101-2 is out of the target track when the track jump is finished, and accordingly, control of the servo system is unstable.

### DISCLOSURE OF INVENTION

Technical Solution

The present invention provides a track jump apparatus and method which perform a stable search operation when data record/playback in an optical recording medium is performed by performing track jumping in consideration of the position of a pickup and the position of a lens of the pickup in an optical recording medium and system with eccentricity.

Advantageous Effects

As described above, a track jump method which performs track jumping in consideration of a position of a pickup according to the present invention can stably perform a search operation by determining a time of the track jump considering a lens position of the pickup in an optical recording medium and system with eccentricity. For record/playback operations of an optical disc, a plurality of track jumps are performed. With the present invention, data transmission is normally performed by saving the time required for the retry when a track jump operation fails. In particular, except for physical things such as a distance between tracks, since internal/external eccentricity components of a system do not affect track jumping, system stability increases.

### DESCRIPTION OF DRAWINGS

FIG. 1 is a block diagram of a conventional servo system for a track jump;

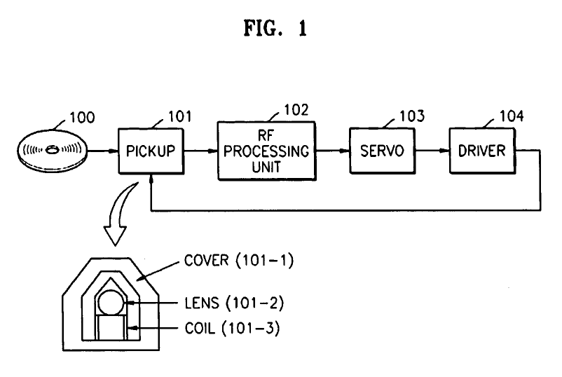

FIG. 2 is a block diagram of a track jump apparatus which performs track jumping in consideration of a position of a pickup awarding to the present invention; and

FIG. 3 is a flowchart of a track jump method which performs track jumping in consideration of a position of a pickup according to the present invention.

### BEST MODE

According to an aspect of the present invention, there is provided a track jump apparatus which performs track jumping in consideration of a position of a pickup, the apparatus including: a pickup, which reads a signal from an optical disc; an RF processing unit, which outputs an error signal controlling the pickup by shaping and amplifying a signal transmitted from the pickup; a servo, which judges a position of the pickup from the error signal output from the RF processing unit and outputs a track jump start/end control signal; and a driver, which moves the position of the pickup using the track jump start/end control signal output from the servo.

It is preferable that in a case where the position of the pickup judged by the error signal output from the RF processing unit is within a reference range, the servo outputs a predetermined voltage for the track jump start/end control to the driver.

It is preferable that in a case where the position of the pickup judged by the error signal output from the RF processing unit does not fall within the reference range, the servo cuts off the predetermined voltage for the track jump start/end control output to the driver until the position of the pickup is within the reference range.

According to an aspect of the present invention, there is provided a track jump method which performs track jumping in consideration of a position of a pickup, the method including: (a) outputting an error signal controlling the pickup by shaping and amplifying an optical disc signal transmitted from the pickup; (b) judging a position of the pickup from the error signal when a track jump is performed and outputting a track jump start/end control signal for the pickup; and (c) moving the position of the pickup using the track jump start/end control signal.

It is preferable that step (b) includes; (b-1) in a case where the position of the pickup judged by the error signal is within a reference range, outputting a predetermined voltage for the track jump start/end control; and (b-2) in a case where the position of the pickup judged by the error signal exceeds the reference range, cutting off the predetermined voltage for the track jump start/end control until the position of the pickup is within the reference range.

Mode for Invention

Hereinafter, the present invention will now be described in detail with reference to the attached drawings.

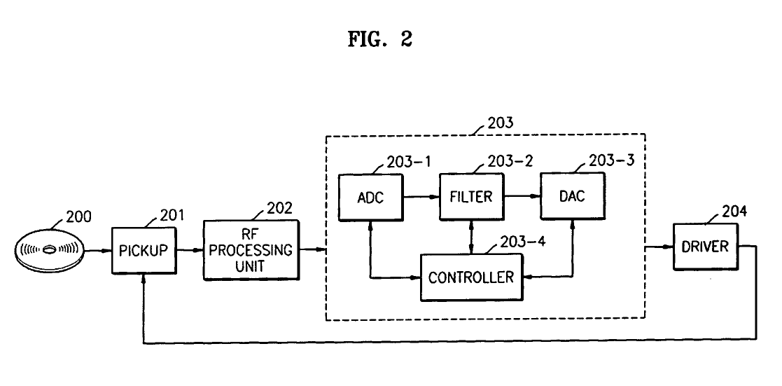

FIG. 2 is a block diagram of a track jump apparatus which performs track jumping in consideration of a position of a pickup according to the present invention.

With reference to FIG. 2, the apparatus includes an optical disc 200, a pickup 201, an RF processing unit 202, a servo 203 including an analog-to-digital converter (ADC) 203-1, a filter 203-2, a digital-to-analog converter (DAC) 203-3, and a controller 203-4, and a driver 204.

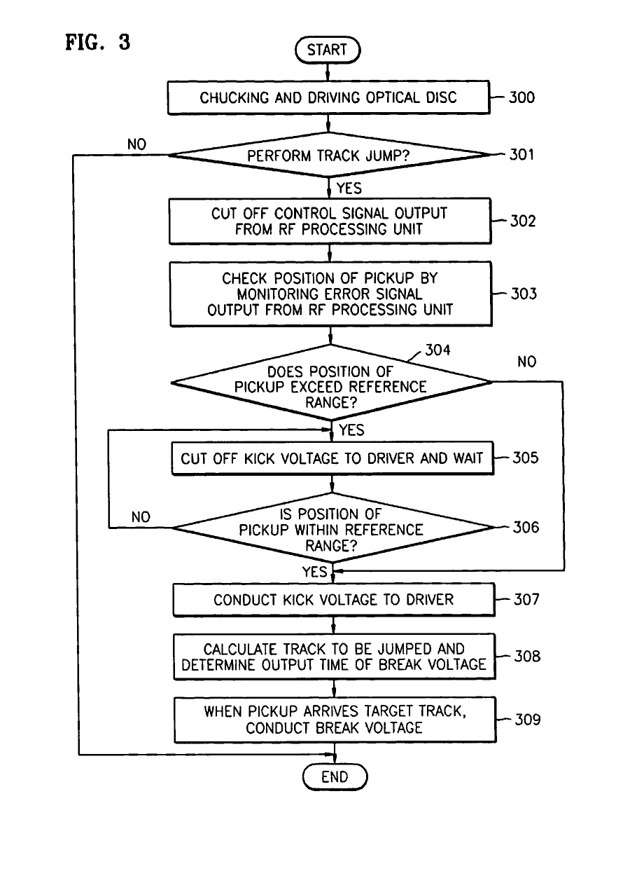

FIG. 3 is a flowchart of a track jump method which performs track jumping in consideration of a position of a pickup according to the present invention.

With reference to FIGS. 2 and 3, the track jump apparatus and method considering a position of a pickup will now be described in detail.

First, with reference to FIG. 2, the track jump apparatus which performs track jumping in consideration of a position of a pickup will now be described in detail.

When the pickup 201 is tracking the optical disc 200, the RF processing unit 202 amplifies an RF signal transmitted from the pickup 201 to a predetermined value and generates an error signal (a focus error (FE) and tracking error (TE) signal) using the amplified RF signal. The FE and TE signals are generated using the RF signal according to a conventional method.

The error signal generated in the RF processing unit 202 is input to the servo 203. The servo 203 converts the error signal output from the RF processing unit 202 into a digital signal, performs filtering of the digital signal, and outputs an error compensation signal, which is a control signal. In particular, the servo 203 judges a position of the pickup 201 from the error signal output from the RF processing unit 202 when a track jump of the optical disc 200 is performed and outputs a track jump start/end control signal for the pickup 201.

The ADC 203-1 included in the servo 203 converts the error signal output from the RF processing unit 202 into the digital signal.

The filter 203-2 included in the servo 203 performs filtering of the digital error signal output from the ADC 203-1 with a predetermined frequency component in order to control the pickup 201.

The DAC 203-3 included in the servo 203 converts the filtered signal output from the filter 203-2 into an analog signal and outputs the analog signal to the driver 204.

The controller 203-4 included in the servo 203 controls the operation of the ADC 203-1, the filter 203-2, and the DAC 203-3.

If the pickup 201 is normally tracking the optical disc 200, the RF processing unit 202 generates an error signal from an output signal of the pickup 201, and the servo 203 performs A-to-D conversion, filtering, and D-to-A conversion of the generated error signal and outputs an error compensation signal controlling movement of the pickup 201.

However, if the pickup 201 performs a track jump while tracking a track, the controller 203-4 cuts off the error compensation signal output to the driver 204. Then, the controller 203-4 determines a track position of a lens of the pickup 201 by monitoring the digital error signal output from the ADC 203-1. The controller 203-4 stores a reference range for outputting a kick voltage and a break voltage to the driver 204 in order to move the pickup 201 when a track jump is performed. The controller 203-4 judges whether a current track position of the lens of the pickup 201 is within the reference range.

If a position on tracks of the lens of the pickup 201 is within the reference range, that is, in a case where the position of the lens of the pickup 201 is around the track center, the controller 203-4 performs a track jump by conducting the kick voltage to the driver 204.

However, if a track position of the lens of the pickup 201 exceeds the reference range, that is, in a case where the position of the lens of the pickup 201 is far from the track center, the controller 203-4 cuts off the kick voltage to the driver 204 and waits. Then, if a current track position of the lens of the pickup 201 is within the reference range, that is, in a case where the position of the lens of the pickup 201 is around the track center, the controller 203-4 performs a track jump by conducting the kick voltage to the driver 204.

The controller 203-4 calculates a target track to be jumped and sets an output time of the break voltage. When the pickup arrives at the target track, the controller 203-4 conducts the break voltage to the driver 204.

Next, with reference to FIG. 3, the track jump method which performs track jumping in consideration of a position of a pickup will now be described in detail.

When the optical disc 200 is chucked on a tray (not shown) and driven in step 300, the controller 203-4 judges in step 301 whether the pickup 201 has performed a track jump.

If the pickup 201 is normally tracking the optical disc 200, the RF processing unit 202 generates an error signal from an output signal of the pickup 201, and the servo 203 performs A-to-D conversion, filtering, and D-to-A conversion of the generated error signal and outputs an error compensation signal controlling movement of the pickup 201.

In a case where the pickup 201 performs a track jump, the controller 203-4 cuts off a control signal transmitted to the driver 204 in step 302.

The controller 203-4 determines a track position of the pickup 201 in step 303 by monitoring the error signal output from the RF processing unit 202. The RF processing unit 202 amplifies an RF signal transmitted from the pickup 201 to a predetermined value and generates an error signal (a focus error (FE) and tracking error (TE) signal) using the amplified RF signal. The ADC 203-1 converts the error signal output from the RF processing unit 202 into a digital signal and outputs the digital signal to the controller 203-4. The controller 203-4 can determines the track position of the pickup 201 by monitoring the digital error signal output from the ADC 203-1.

The controller 203-4 judges in step 304 whether or not the position of the pickup 201 exceeds a reference range. The controller 203-4 stores a reference range for conducting a kick voltage and a break voltage to the driver 204 in order to move the pickup 201 when a track jump is performed.

If a position of the pickup 201 exceeds the reference range, that is, in a case where a position of a lens of the pickup 201 is far from the track center, the controller 203-4 cuts off the kick voltage to the driver 204 and waits in step 305.

The controller 203-4 judges whether a position on tracks of the pickup 201 is within the reference range. If a track position of the lens of the pickup 201 is within the reference range in step 306, that is, in a case where the position of the lens of the pickup 201 is around the track center, the controller 203-4 conducts the kick voltage to the driver 204 in step 307.

After the kick voltage has been conducted to the drive, the controller 203-4 calculates a target track to be jumped and determines an output time of the break voltage in step 308.

When the pickup 201 arrives at the target track, the controller 203-4 conducts the break voltage to the driver 204 in step 309.

1. An apparatus for performing track jumping in consideration of a position of a pickup, the apparatus comprising:
a pickup reading a signal from an optical disc;
an RF processing unit outputting an error signal controlling the pickup by shaping and amplifying the signal transmitted from the pickup;
a servo judging a position of the pickup based on the error signal output from the RF processing unit and outputting a track jump start/end control signal;
and a driver moving the position of the pickup using the track jump start/end control signal output from the servo.

2. The apparatus of claim 1, wherein:
where the position of the pickup judged by the error signal output from the RF processing unit is within a reference range, the servo outputs a predetermined voltage for the track jump start/end control to the driver.

3. The apparatus of claim 1, wherein:
where the position of the pickup judged by the error signal output from the RF processing unit is not within the reference range, the servo cuts off the predetermined voltage for the track jump start/end control output to the driver until the position of the pickup is within the reference range.

4. A method of performing track jumping in consideration of a position of a pickup, the method comprising:
outputting an error signal controlling the pickup by shaping and amplifying an optical disc signal transmitted from the pickup;
judging a position of the pickup from the error signal when a track jump is performed and outputting a track jump start/end control signal for the pickup; and
moving the position of the pickup using the track jump start/end control signal.

5. The method of claim 4, wherein:
where the position of the pickup judged by the error signal is within a reference range, the outputting of the track jump start/end control signal comprises outputting a predetermined voltage; and
where the position of the pickup judged by the error signal is not within the reference range, the outputting of the track jump start/end control signal comprises cutting off the predetermined voltage until the position of the pickup is within the reference range.

6. An apparatus for performing track jumping of an optical pickup in an optical disc recording/reproducing apparatus, the apparatus comprising:
an RF processing unit generating a positional error signal based on an output signal of the optical pickup;
a servo judging a position of the pickup relative to a track of the optical disc based on the positional error signal, and outputting a control signal to control a position of the optical pickup based on the judged position;
a driver controlling the position of the pickup using the control signal output; and
a controller monitoring the control signal and controlling the track jumping based on the control signal, wherein:
where the controller determines that the control signal represents that the position of the optical pickup is within a predetermined range of a center of the track, the controller immediately outputs an additional signal to the driver to perform the track jump, and
where the controller determines that the control signal represents that the position of the optical pickup is not within the predetermined range, the controller delays outputting the additional signal to the driver until the control signal represents that the position of the optical pickup is within the predetermined range of the track center.

7. The apparatus of claim 6, wherein:
the controller calculates an amount of the track jump and calculates a duration of the additional voltage based on the calculated amount of the track jump.

8. The apparatus of claim 6, wherein:
the controller removes the additional voltage when the pickup has completed the track jump.

9. A method of controlling track jumping of an optical pickup relative to an eccentrically rotating track of an optical disc, the method comprising:
judging whether a position of the pickup is within a predetermined range relative to a center of the track at a time of a track jump command;
immediately outputting the track jump command to the optical pickup if the pickup is within the predetermined range; and
delaying the outputting of the track jump command if the pickup is not within the predetermined range.
